(19) United States
(12) Patent Application Publication
(10) Pub. No.: US 2009/0319532 A1
(43) Pub. Date: Dec. 24, 2009

(54) METHOD OF AND SYSTEM FOR MANAGING REMOTE STORAGE

(76) Inventors: Jens-Peter Akelbein, Mainz (DE); Nils Haustein, Soergenloch (DE); Sven Oehme, Mainz (DE)

Correspondence Address: DILLON & YUDELL LLP, 8911 NORTH CAPITAL OF TEXAS HWY, SUITE 2110, AUSTIN, TX, 78759, US

(21) Appl. No.: 12/144,012

(22) Filed: Jun. 23, 2008

(51) Int. Cl. G06F 17/30

(52) U.S. Cl. 707/10; 707/E17.032

(57) ABSTRACT

A method of managing remote storage sets retention grace period, an archive retention period, and a backup retention period all equal to the same time period. In response to receiving a request to migrate a file to remote storage by any one of HSM, archive, or backup, the method creates a stub of the file, stores the stub in local storage, moves the file to remote storage, and backs up the file at the remote storage. In response to receiving a request to access an HSM file, the method determines if the requested file is in HSM remote storage; if so, the method returns the requested file from remote storage; if not; the method determines if the requested file is in archive remote storage or backup storage and, if so, returns the requested file from said remote storage. In response to receiving a request to access an archived file, the method determines if the requested file is in archive remote storage; if so, the method returns the requested file; if not, the method determines if the requested file is in HSM remote storage or backup remote storage and, if so, returns the requested. In response to receiving a request to access a backup file, the method determines if the requested file is in backup remote storage; if so, the method returns the requested file; if not, the method determining if the requested file is in archive remote storage or HSM remote storage and, if so, returns the requested file.

### BACKGROUND OF THE INVENTION

1. Technical Field

The present invention relates in general to the field of remote data storage and more particularly to a method of and system for managing remote storage by integrating hierarchical storage management (HSM), backup storage, and archive storage.

2. Description of the Related Art

Remote storage of data is typically implemented using storage management systems, which are implemented in a client-server-architecture. Remote storage represented by storage management systems typically provide data services in accordance with different methods to host systems such as backup, archive and hierarchical storage management. Host systems that use remote storage include client systems that transfer data objects to a storage management server via a network according to different methods. Each method has a particular purpose, interface and parameters. For example, one client system may offer a backup method, while another client system may offer an archive method, while yet another client system may offer a hierarchical storage management (HSM) function. A typical host system includes clients that implement all three methods. The clients work independently and agnostically of each other.

The purpose of the backup method is to protect a data object by creating multiple copies of the object. One copy remains on client system and one or more copies reside in the storage management server on different storage media. The backup client uses a backup interface incorporating backup specific protocols such as the IBM Tivoli Storage Manager TSM backup API. Special parameters used for backup are for example the number of versions to be kept for a particular data object or the amount of time to retain the latest version of a particular data object.

The purpose of the archive method is to retain a data object by moving it to an archive system. The primary instance of a data object resides in the storage management server and is usually not longer stored in the client system. The client uses an archive interface incorporating archive specific protocols such as the TSM archive API. Special parameters used for archive are for example the retention time period specifying how long an object is to be archived, the retention policy which might support events and metadata allowing it to be stored with the actual data.

The purpose of the HSM method is to move or migrate a data object from a high-cost storage media to a low-cost storage media based on policies. The main objective of HSM is cost saving. HSM allows transparent access to the data object through a so called “stub file” which is placed in storage media of client system. If client system requires access to a data object it accesses the “stub file” which invokes the HSM client function to recall the data from the secondary storage media and copy it to the client system. The client uses an HSM interface incorporating HSM specific protocols such as the TSM HSM Interface. Special parameters used for HSM include for example the retention grace period which specifies how long a data is kept by the server when it has been deleted by the client.

Storage management systems according to prior art such as IBM Tivoli Storage Manager typically support these different data storage methods while the methods are usually implemented as separate functions or client modules that are not integrated. Thus the storage management system has usually no knowledge that a backup data object has also been archived or that a HSM data object has also been backed up or that an archive data objects has been migrated by the HSM function. Manual intervention is required to restore a data object through the backup when the object becomes lost for the HSM client (due to an error). Likewise manual intervention is required to recall a data object through the HSM client when it becomes lost by the backup client (due to an error). In addition HSM represents an optimal technology for archiving because it removes the data from the primary storage system. Thus a close integration of HSM with archiving is desirable whereby the HSM moves data into an archive.

For certain data storage methods such as archiving there might be a demand to store data and metadata. The data contains the actual information to be archived. The metadata contains information about the data such as the data format, a description how the data format can be visualized, attributes for the data stored (creation data, expiration date, owner, access control) and further index information such as a full text index.

The storage requirements for data and metadata are different. For example metadata might be stored in a database to enable effective search and retrieval. Data might just be stored on a storage medium represented by a file system. In addition the requirements for scalability are different for data and metadata. The metadata scalability relates to the capabilities of the database whereas the scalability of for the data is more focused on storage capacities. Therefore it might be useful to separate data and metadata before ingesting it into a storage management system.

### SUMMARY OF THE INVENTION

The present invention provides a method of managing remote storage. The method sets a hierarchical storage management (HSM) retention grace period, an archive retention period, and a backup retention period all equal to the same time period. In response to receiving a request to migrate a file to remote storage by any one of HSM, archive, or backup, the method creates a stub of the file, stores the stub in local storage, moves the file to remote storage, and backs up the file at the remote storage. In response to receiving a request to access an HSM file, the method determines if the requested file is in HSM remote storage; if so, the method returns the requested file from remote storage; if not; the method determines if the requested file is in archive remote storage or backup storage and, if so, returns the requested file from said remote storage. In response to receiving a request to access an archived file, the method determines if the requested file is in archive remote storage; if so, the method returns the requested file; if not, the method determines if the requested file is in HSM remote storage or backup remote storage and, if so, returns the requested. In response to receiving a request to access a backup file, the method determines if the requested file is in backup remote storage; if so, the method returns the requested file; if not, the method determining if the requested file is in archive remote storage or HSM remote storage and, if so, returns the requested file.

Embodiments of the present invention may also be used to separate the data and metadata associated with backup, archive and HSM operations. In particular when the invention is used for archiving, the separation of data and metadata might be very useful since it can be stored in different partitions of a storage management server providing different characteristics. For example, metadata might be stored in a database pertaining to storage management system and data might be stored on the storage medium in a file system or in a container. This enables data or metadata specific scalability and data management.

In addition, embodiments of the present invention allow the aggregation of metadata for multiple objects. The rationale is the amount of metadata being stored in a storage system impacts the system performance: as more metadata is stored as lower the performance. Therefore the aggregation of metadata is advantageous because is decreases the amount of metadata by aggregating identical metadata for multiple objects.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a flow chart of an embodiment of hierarchical storage management (HSM) client processing according to the present invention;

FIG. 3 is a flow chart of an embodiment of archive client processing according to the present invention;

FIG. 4 is a flow chart of an embodiment of backup client processing according to the present invention;

FIG. 5 is a flow chart of an embodiment of integrator processing of an HSM client request according to the present invention;

FIG. 6 is a flow chart of an embodiment of integrator processing of an archive client request according to the present invention; and,

FIG. 7 is a flow chart of an embodiment of integrator processing of a backup client request according to the present invention.

### DETAILED DESCRIPTION OF THE PREFERRED EMBODIMENT

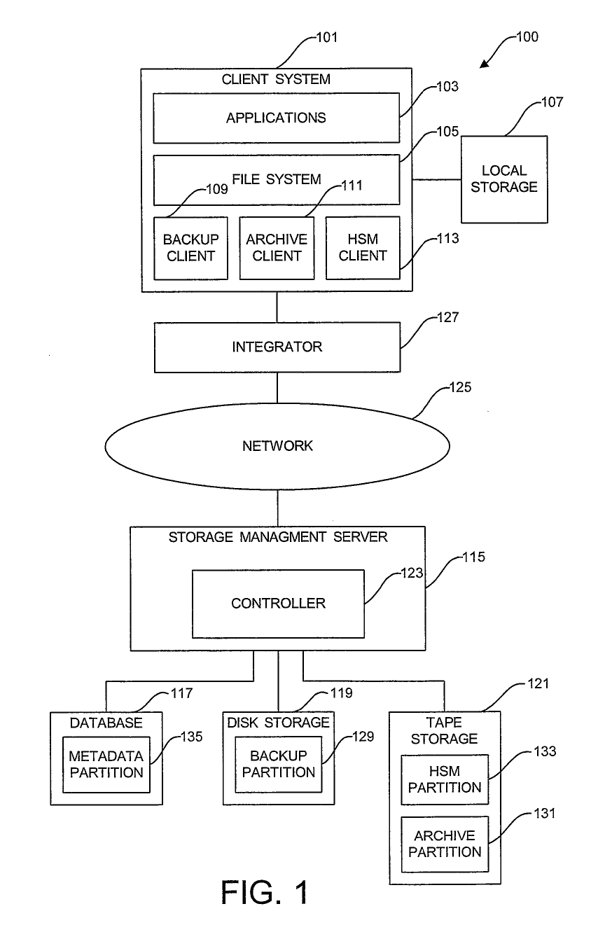

Referring now to drawings, and first to FIG. 1, an embodiment of a system according to the present invention is designated generally by the numeral 100. System 100 includes a client system 101. Client system 101 may be any computer. Client system 101 includes application programs 103 that create and use data. System 101 also includes a file system 105, which manages logical files created and used by client system 101. Client system 101 includes or is coupled to local storage 107 that is used by file system 105 to physically store files created and used by client system 101.

Client system 101 includes a backup client 109, and archive client 111, and a hierarchical storage management (HSM) client 113. Backup client 109 is invoked to copy files from local storage 107 to remote storage. Backup client 109 provides a data security feature by which current local data that may have become lost or corrupted may be recovered from remote storage. Archive client 111 is invoked to move old data from local storage 107 to remote storage. Archive client 111 provides a feature by which data is removed from local storage but remains available for future recovery from remote storage should the need arise. HSM client 113 is invoked to move current data from high cost local storage 107 to lower cost remote storage. HSM client 113 creates a stub that represents a file in file system 105 and moves the file represented by the stub to remote storage. When a user wants to open a file represented by the stub, HSM client 113 retrieves the file from remote storage. As used herein, the term copy means to retain the original file in local storage and store a copy of the file in remote storage. The term move means to delete the original file from local storage and store a copy of the file in remote storage.

System 100 includes a storage management server 115, which provides remote storage services. Storage management server 115 is coupled to storage media such as a database 117, disk storage 119, and tape storage 121. Storage management server 115 includes a controller 123, which sends files to and retrieves files from the storage media. Storage management server 115 provides a storage partition 129 for the backup data, a storage partition 131 for the archive data, and a storage partition 133 for the HSM data. These storage partitions might be based on one and the same storage medium such as disk storage 119 or tape storage 121, or these partitions might be on distinct storage media such as disk storage 119 and tape storage 121 or any other storage technology such as optical storage (e.g. CD, DVD, holographic storage). In the preferred embodiment the storage partitions are on distinct storage media (such as disk and tape). When storage management server 115 receives a request to store a backup object then it will store the backup object on the storage partition 129 for the backup data. Likewise when storage management server 115 receives a request to store an archive object it is stored in the storage partition 131 for archive data and HSM data is stored in the storage partition 133 for HSM data. Storage management server 115 may also provide a partition 135 for metadata.

Client system 101 and storage management server 115 transfer files back and forth over a network 125. Typically, multiple client systems 101 are coupled to network 125. In the illustrated embodiment, an integrator 127 sits between client system 101 and network 125. Integrator 127 may be implemented as a component of client system 101 or it may be a standalone system. Integrator 127 is programmed according to the present invention to integrate the functions of backup client 109, archive client 111, and/or HSM client 113. In other embodiments, the functions of integrator 127 may be integrated into backup client 109, archive client 111, and/or HSM client 113.

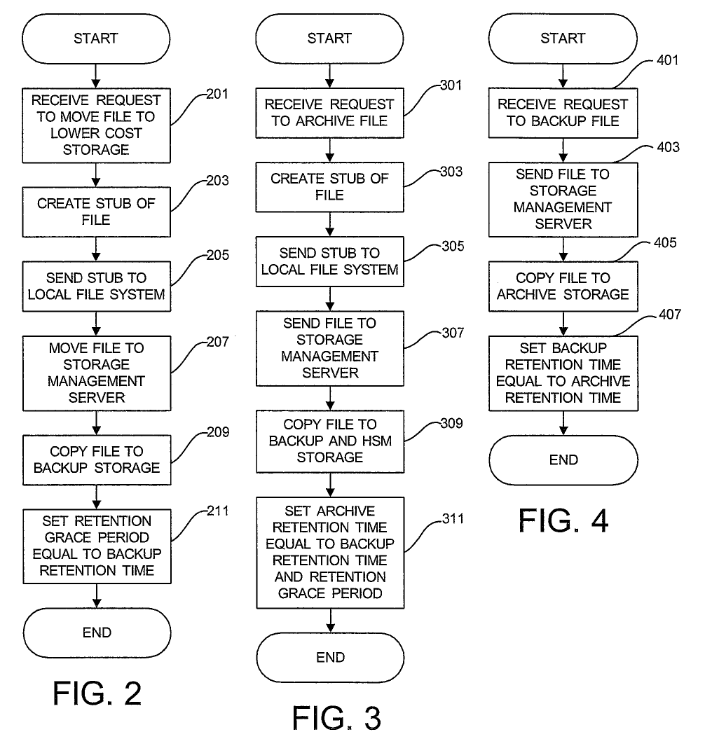

FIG. 2 is a flow chart of an embodiment of HSM client 113 processing according to the present invention. HSM client 113 receives a request to move a file from the local file system 105 to lower costs storage provide by the storage management server 115, at block 201. HSM client 113 creates a stub of the file, at block 203, and sends the stub to local file system 105, at block 205. HSM client 113 moves the file to storage management server 115, at block 207, which stores the file in the storage partition 133 for HSM data. Also according to the present invention, HSM client 113, or integrator 127, copies the file to backup storage partition 129 controlled by storage management server 115, as indicated at block 209. The system of the present invention harmonizes the HSM and backup operations by setting retention grace period for the file equal to the backup retention time, as indicated at block 211. The user of the client system 100 sees the operation as an HSM transaction. However, HSM client 113, and/or integrator 127, combine the HSM and backup functions.

FIG. 3 is a flow chart of an embodiment of archive client 111 processing according to the present invention. Archive client 111 receives a request to move a file to archive storage, at block 301. Archive client 111 creates a stub of the file, at block 303, and sends the stub to local file system 105, at block 305. Archive client 111 moves the file to storage management server 115, at block 307, which stores the file in the storage partition 131 for archive data. Also according to the present invention, archive client 111, or integrator 127, copies the file to backup storage partition 129 and the HSM storage partition 133 controlled by storage management server 115, as indicated at block 309. Again, the system of the present invention harmonizes the HSM, backup, and archive operations by setting the archive retention time for the file equal to a retention grace period and backup retention time, as indicated at block 311. Thus, while the user sees an archive transaction, archive client 111, and/or integrator 127, combine the HSM, archive, and backup functions.

FIG. 4 is a flow chart of an embodiment of backup client 109 processing according to the present invention. Backup client 109 receives a request to copy a file to backup storage, at block 401. Backup client 109 copies the file to storage management server 115, at block 403, which stores the file in the storage partition 129 for backup data. Also according to the present invention, backup client 109 copies the file to archive storage partition 131 controlled by storage management server 115, as indicated at block 405. Again, the system of the present invention harmonizes the backup and archive operations by setting backup retention times for the file equal to the archive retention time, as indicated at block 407. Thus, while the user sees a backup transaction, backup client 109 combines the backup and archive functions.

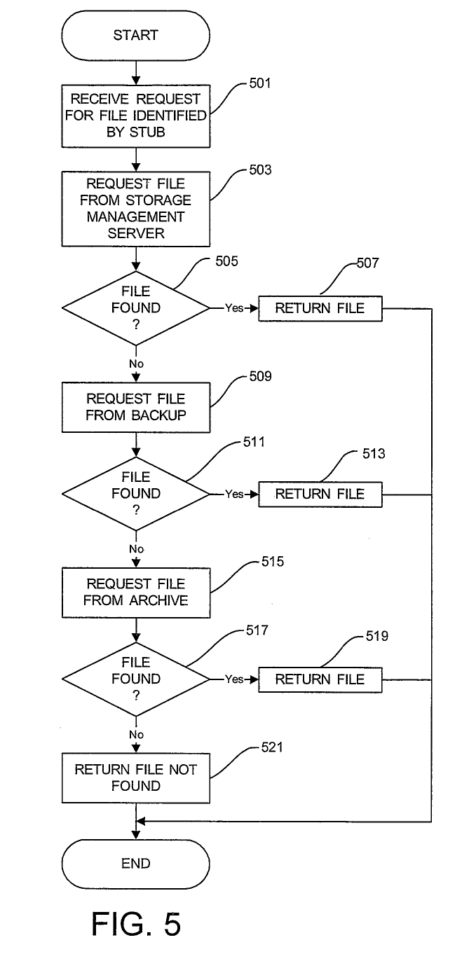

FIG. 5 is a flow chart of an embodiment of integrator 127 processing of an HSM recall request for a file being migrated by the HSM client 113 according to the present invention. Integrator 127 receives a request for a file identified by a stub, at block 501. Integrator 127 requests the file from the HSM storage partition 133 of the storage management server 115, at block 503. If, as determined at decision block 505, the requested file is found in HSM storage partition 133, integrator 127 returns the file, at block 507. If the file is not found in HSM storage partition 133, integrator 127 requests the file from backup storage partition 129, at block 509. If, as determined at decision block 511, the file is found in backup storage partition 129, integrator 127 returns the file, as indicated at block 513. If the file is not found in backup storage partition 129, integrator 127 requests the file from archive storage partition 131, at block 515. If, as determined at decision block 517, the file is found in archive storage partition 131, integrator 127 returns to file, at block 519. If the file is not found in archive storage partition 131, integrator 127 returns an error indicating file not found, at block 521.

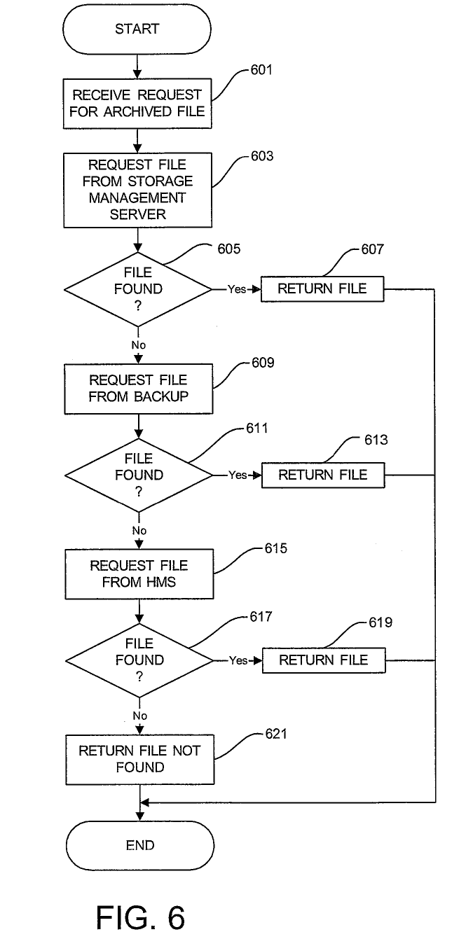

FIG. 6 is a flow chart of an embodiment of integrator 127 processing of a retrieval request for file archived by the archive client 111 according to the present invention. Integrator 127 receives a retrieve request for an archived file, at block 601. Integrator 127 requests the file from archive storage partition 131 of storage management server 115, at block 603. If, as determined at decision block 605, the requested file is found archive storage partition 131, integrator 127 returns the file, at block 607. If the file is not found in archive storage partition 131, integrator 127 requests the file from backup storage partition 129, at block 609. If, as determined at decision block 611, the file is found in backup storage partition 129, integrator 127 returns the file, as indicated at block 613. If the file is not found in backup storage partition 129, integrator 127 requests the file from HSM storage partition 133, at block 615. If, as determined at decision block 617, the file is found in HSM storage partition 133, integrator 127 returns to file, at block 619. If the file is not found in HSM storage partition 133, integrator 127 returns an error indicating file not found, at block 621.

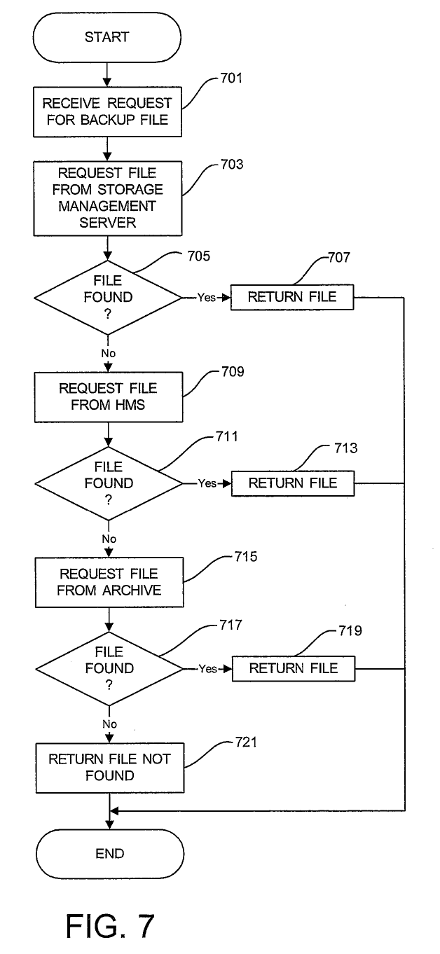

FIG. 7 is a flow chart of an embodiment of integrator 127 processing of restore request of a file which was backed up by the backup client 109 according to the present invention. Integrator 127 receives a restore request for a backup file, at block 701. Integrator 127 requests the file from backup storage partition 129 of storage management server 115, at block 703. If, as determined at decision block 705, the requested file is found in backup storage partition 129, integrator 127 returns the file, at block 707. If the file is not found in the backup storage partition 129, integrator 127 requests the file from HSM storage partition 133, at block 709. If, as determined at decision block 711, the file is found in HSM storage partition 133, integrator 127 returns the file, as indicated at block 713. If the file is not found in HSM storage 129, integrator 127 requests the file from archive storage partition 131, at block 715. If, as determined at decision block 717, the file is found in archive storage partition 131, integrator 127 returns to file, at block 719. If the file is not found in archive storage 127, integrator 127 returns an error indicating file not found, at block 721.

The architecture of the present invention allows for the separation of data and metadata. Returning to FIG. 1, integrator 127 receives the data from, for example, archive client 111. Archive client 111 may send both data and metadata to integrator 127. Data and metadata might be sent as one object or as distinct objects. The data contains the actual information to be archived. The metadata contains information about the data, such as the data format, a description how the data format can be visualized, attributes for the data stored (creation date, expiration date, owner, access control) and further index information such as a full text index. Integrator 127 detects the metadata based on its format and stores it in metadata storage partition 135 of storage management server 115. The associated data is stored in archive storage partition 131 of storage management server 115. Archive storage partition 131 and metadata storage partition 135 are different. For example the storage partition for metadata is a database 117 allowing to search for metadata information. The storage partition for archive data might be on disk 119 or tape 121 as shown in FIG. 1.

Storing the data and metadata in different partitions enables distinct management. For example metadata might be inserted into a database 117 where effective queries can be done for search and retrieve purposes. The data might just be stored on a storage medium in a file or a container. The separation of data and metadata in distinct partitions also allows scalability because the metadata partition scales by the database performance and the processor and memory size. The data partition scales by the storage capacity provided.

The ability of integrator 127 to separate data and metadata can also be used to aggregate metadata. Typically for file backup and archiving processes bulks of files are transmitted from client system 101 to the storage management server 115. Usually the metadata portions for many files transferred in a bulk are identical, such as the ACL, directory names, retention times and versions. Integrator 127 separates the data and the metadata. In addition integrator 127 can aggregate identical portions of metadata in order to decrease the total amount of metadata. The aggregation may be time based, i.e. metadata is aggregated for objects transferred in a certain time frame. The aggregation can also be based on efficiency, i.e. as long as portions from many objects are identical aggregation continues. If the number identical portions of metadata falls below a certain threshold then the aggregation is stopped. In this way the overall amount of metadata can be decreased, thereby allowing storage management server 115 to perform more efficiently.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

1. A method of managing remote storage, which comprises:
providing a storage management server, said storage management server providing distinct storage partitions for archive, backup and hierarchical storage management (HSM) data;
providing an archive client, a backup client, and an HSM client, each of said clients being connected to the storage management server;
providing an integrator placed in between the client systems and the storage management server, said integrator intercepting backup, archive or HSM file operations and creating additional copies of a backup, archive or HSM file;
in response to receiving a request from the HSM client to migrate a file to remote HSM storage;
creating a stub of said file to be migrated to said remote HSM storage;
storing said stub in local storage;
moving said file to be migrated to said remote HSM storage to the HSM storage partition of said remote storage;
copying said file to be migrated to said remote HSM storage to said remote storage in the backup storage partition; and
setting a retention grace period equal to a backup retention time for said file to be migrated to said remote HSM storage;
in response to receiving a request from the archive client to archive a file to remote archive storage;
creating a stub of said file to be archived;
storing said stub in local storage;
moving said file to be archived to the archive storage partition of said remote storage;
copying said file to be archived to said remote storage in the backup and HSM storage partitions; and
setting an archive retention time equal to the retention grace period and the backup retention time for said file to be archived;
in response to receiving a request from the backup client to backup a file to remote backup storage;
copying said file to be backed up to the backup storage partition of said remote storage;
copying said file to be backed up to the archive and HSM storage partitions of said remote storage; and
setting the backup retention time equal to the retention grace period and the archive retention time for said file to be backed up;
in response to receiving a request to access an HSM file;
determining if said requested HSM file is in HSM storage partition;
if said requested HSM file is in HSM storage partition, returning said requested HSM file from said remote storage;
if said requested HSM file is not in said HSM storage partition, determining if said requested HSM file is in archive or backup storage partition;
if said requested HSM file is in said archive or said backup storage partition, returning said requested HSM file from said remote storage;
in response to receiving a request to access an archive file;
determining if said requested archive file is in archive storage partition of the remote storage;
if said requested archive file is in archive storage partition, returning said requested archive file from said archive storage partition;
if said requested archive file is not in said archive storage partition, determining if said requested archive file is in HSM or backup storage partition;
if said requested file archive is in said HSM storage partition or said backup remote storage, returning requested archive file;
in response to receiving a request to access a backup file;
determining if said requested backup file is in said backup storage partition;
if said requested backup file is in said backup storage partition, returning said requested backup file;
if said requested backup file is not in said backup storage partition,
determining if said requested backup file is in archive or HSM storage partition;
if said requested backup file is in said archive or HSM storage partition, returning said requested backup file.
